(19) United States
(12) Patent Application Publication
(10) Pub. No.: US 2019/0259335 A1
(43) Pub. Date: Aug. 22, 2019

(54) PIXEL DRIVING CIRCUITRY AND METHOD FOR DRIVING THE SAME, DISPLAY SUBSTRATE AND DISPLAY DEVICE

(71) Applicant: BOE Technology Group Co., Ltd., Beijing (CN)

(72) Inventors: Shengji Yang, Beijing (CN); Xue Dong, Beijing (CN); Jing Lv, Beijing (CN); Xiaochuan Chen, Beijing (CN); Can Zhang, Beijing (CN)

(73) Assignee: BOE Technology Group Co., Ltd., Beijing (CN)

(21) Appl. No.: 15/738,517

(22) PCT Filed: Jun. 12, 2017
(86) PCT No.: PCT/CN2017/087895

§ 371 Date: Dec. 20, 2017

(30) Foreign Application Priority Data
Oct. 28, 2016 (CN) 201610966857.8

(51) Int. Cl. G09G 3/3258

(52) U.S. Cl. CPC G09G 3/3258; G09G 2320/0233; G09G 2300/0842; G09G 2300/043; G09G 2300/0426

(57) ABSTRACT

A pixel driving circuitry and a method for driving the same, a display substrate and a display device are provided. The pixel driving circuitry includes N pixel driving sub-circuits coupled to an identical data line, an n^{th} pixel driving sub-circuit is configured to drive a light-emitting component of an n^{th} pixel unit to emit light, where N is an integer larger than 1, and n is a positive integer smaller than or equal to N. The n^{th} pixel driving sub-circuit includes an n^{th} reset circuit, an n^{th} driving transistor, an n^{th} charge-discharge circuit, an n^{th} compensation control circuit and an n^{th} light-emitting control circuit.

### CROSS-REFERENCE TO RELATED APPLICATION

This application is the U.S. national phase of PCT Application PCT/CN2017/087895 filed on Jun. 12, 2017, which claims priority to Chinese Patent Application No. 201610966857.8 filed Oct. 28, 2016, the disclosures of which are incorporated in their entirety by reference herein.

### TECHNICAL FIELD

The present disclosure relates to the field of display driving technology, and in particularly to a pixel driving circuitry and a method for driving the same, a display substrate and a display device.

### BACKGROUND

In a pixel driving circuitry in the related art, one data line provides the data voltage for only one column of pixel driving sub-circuits, so it is unable to reduce significantly the number of thin film transistors (TFT) for compensation and data lines. As a result, it is unable to reduce significantly the pixel pitch and a cost of an integrated circuit (IC). Therefore, it is unable to spare more data lines to arrange the IC channels, and it is unable to solve the technical issue of the uneven display due to the inhomogenous threshold voltage caused by a technological process and a long time operation of the pixel-driven TFT while achieving more pixels per inch (PPI).

### SUMMARY

The present disclosure is to provide a pixel driving circuitry and a method for driving the same, a display substrate and a display device.

A pixel driving circuitry is provided in the present disclosure, including N pixel driving sub-circuits coupled to an identical data line, where an n^{th} pixel driving sub-circuit is configured to drive a light-emitting component of an n^{th} pixel unit to emit light, where N is an integer larger than 1, and n is a positive integer smaller than or equal to N; the n^{th} pixel driving sub-circuit includes an n^{th} reset circuit, an n^{th} driving transistor, an n^{th} charge-discharge circuit, an n^{th} compensation control circuit and an n^{th} light-emitting control circuit, where the n^{th} reset circuit is coupled to a reset control signal output end, an n^{th} initial signal output end and an n^{th} control node; a gate electrode of the n^{th} driving transistor is coupled to the n^{th} control node, a first electrode of the n^{th} driving transistor is coupled to the data line via the n^{th} compensation control circuit, and a second electrode of the n^{th} driving transistor is coupled to a first end of the n^{th} charge-discharge circuit via the n^{th} compensation control circuit; the first end of the n^{th} charge-discharge circuit is coupled to the n^{th} control node, and a second end of the n^{th} charge-discharge circuit is coupled to a voltage output end; the n^{th} compensation control circuit is coupled to an n^{th} compensation control signal output end and configured to, during an n^{th} compensation period of a compensation phase and in response to an n^{th} compensation control signal, control the first electrode of the n^{th} driving transistor to receive an n^{th} data voltage on the data line and control the n^{th} charge-discharge circuit to charge or discharge until a potential of the n^{th} control node reaches a sum of a threshold voltage of the n^{th} driving transistor and the n^{th} data voltage; the n^{th} light-emitting control circuit is coupled to the first electrode of the n^{th} driving transistor, the second electrode of the n^{th} driving transistor, a high-level output end, a light-emitting control line and the light-emitting component of the n^{th} pixel unit, and configured to, during a light-emitting phase and in response to a light-emitting control signal output by the light-emitting control line, turn on the n^{th} driving transistor, drive the light-emitting component of the n^{th} pixel unit to emit light and enable a gate-to-source voltage of the n^{th} driving transistor to compensate the threshold voltage of the n^{th} driving transistor.

Optionally, the n^{th} reset circuit includes an n^{th} reset transistor, a gate electrode of the n^{th} reset transistor is coupled to the reset control signal output end, a first electrode of the n^{th} reset transistor is coupled to the n^{th} initial signal output end, and a second electrode of the n^{th} reset transistor is coupled to the n^{th} control node. When the n^{th} driving transistor is a P-type transistor, a difference between an n^{th} initial signal output by the n^{th} initial signal output end and the n^{th} data voltage is smaller than the threshold voltage of the n^{th} driving transistor. When the n^{th} driving transistor is an N-type transistor, a difference between an n^{th} initial signal output by the n^{th} initial signal output end and the n^{th} data voltage is larger than or equal to the threshold voltage of the n^{th} driving transistor.

Optionally, the n^{th} charge-discharge circuit includes an n^{th} storage capacitor, a first end of the n^{th} storage capacitor is coupled to the n^{th} compensation control circuit, and a second end of the n^{th} storage capacitor is coupled to the voltage output end.

Optionally, the n^{th} compensation control circuit includes: a first compensation control transistor, where a gate electrode of the first compensation control transistor is coupled to the n^{th} compensation control signal output end, a first electrode of the first compensation control transistor is coupled to the data line, and a second electrode of the first compensation control transistor is coupled to the first electrode of the n^{th} driving transistor; and a second compensation control transistor, where a gate electrode of the second compensation control transistor is coupled to the n^{th} compensation control signal output end, a first electrode of the second compensation control transistor is coupled to the first end of the n^{th} charge-discharge circuit, and a second electrode of the second compensation control transistor is coupled to the second electrode of the n^{th} driving transistor.

Optionally, the n^{th} light-emitting control circuit includes: a first light-emitting control transistor, where a gate electrode of the first light-emitting control transistor is coupled to the light-emitting control line, a first electrode of the first light-emitting control transistor is coupled to the second electrode of the n^{th} driving transistor, and a second electrode of the first light-emitting control transistor is coupled to the high-level output end; and a second light-emitting control transistor, where a gate electrode of the second light-emitting control transistor is coupled to the light-emitting control line, a first electrode of the second light-emitting control transistor is coupled to the light-emitting component of the n^{th} pixel unit, and a second electrode of the second light-emitting control transistor is coupled to the first electrode of the n^{th} driving transistor.

Optionally, the n^{th} initial signal output end is a ground end, and the voltage output end is coupled to the high-level output end.

A method for driving the above pixel driving circuitry is further provided in the present disclosure, where each display period includes a reset phase, a compensation phase and a light-emitting control phase; the compensation phase includes N compensation periods, where N is a number of pixel driving sub-circuits of the pixel driving circuitry; during each display period, the method includes: during the reset phase, and in response to a reset control signal, controlling, by a reset control circuit, each control node to receive a corresponding initial signal; during an n^{th} compensation period of the compensation phase, and in response to an n^{th} compensation control signal, controlling, by the n^{th} compensation control circuit, the first electrode of the n^{th} driving transistor to receive an n^{th} data voltage on the data line, controlling, by the n^{th} compensation control circuit, the n^{th} control node to connect to the second electrode of the n^{th} driving transistor, and controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage; during the light-emitting phase, and in response to a light-emitting control signal output by the light-emitting control line, turning on the n^{th} driving transistor by the n^{th} light-emitting control circuit, driving, by the n^{th} light-emitting control circuit, the light-emitting component of the n^{th} pixel unit to emit light and enabling a gate-to-source voltage of the n^{th} driving transistor to compensate the threshold voltage of the n^{th} driving transistor; where n is a positive integer smaller than or equal to N.

Optionally, the n^{th} driving transistor is a P-type transistor, and a difference between an n^{th} initial signal and the n^{th} data voltage is smaller than the threshold voltage of the n^{th} driving transistor; the controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage further includes: controlling, by the n^{th} compensation control circuit, the n^{th} charge-discharge circuit to charge until the potential of the n^{th} control node reaches the sum of the threshold voltage of the n^{th} driving transistor and the n^{th} data voltage.

Optionally, the n^{th} driving transistor is an N-type transistor, and a difference between an n^{th} initial signal output by the n^{th} initial signal output end and the n^{th} data voltage is larger than or equal to the threshold voltage of the n^{th} driving transistor; the controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage further includes: controlling, by the n^{th} compensation control circuit, the n^{th}charge-discharge circuit to discharge until the potential of the n^{th} control node reaches the sum of the threshold voltage of the n^{th} driving transistor and the n^{th} data voltage.

A display substrate is further provided in the present disclosure, including a plurality of date lines and a pixel structure; the pixel structure includes a plurality of rows and columns of pixel units arranged in an array and a plurality of pixel driving circuitry hereinabove. N pixel driving sub-circuits of the pixel driving circuitry are coupled to an identical data line; the N pixel driving sub-circuits are respectively coupled to the light-emitting components of N pixel units arranged in a row identical to the N pixel driving sub-circuits, where N is an integer larger than 1.

Optionally, the display substrate further includes a silicon substrate, where the date line, the pixel units and the pixel driving circuitry are arranged on the silicon substrate.

A display device is further provided in the present disclosure, including the above display substrate.

### BRIEF DESCRIPTION OF THE DRAWINGS

FIG. 1 is a schematic view of a pixel driving sub-circuit of a pixel driving circuitry in some embodiments of the present disclosure;

FIG. 2 is a schematic view of a pixel driving circuitry in some embodiments of the present disclosure;

FIG. 3 is a circuit diagram of a pixel driving circuitry in some embodiments of the present disclosure;

FIG. 4 is a schematic view of an operation time sequence of the pixel driving circuitry shown in FIG. 3;

FIG. 5A is a schematic view of a current direction of the pixel driving circuitry shown in FIG. 3 during a reset phase t1;

FIG. 5B is a schematic view of a current direction of the pixel driving circuitry shown in FIG. 3 during a first compensation phase t21;

FIG. 5C is a schematic view of a current direction of the pixel driving circuitry shown in FIG. 3 during a second compensation phase t22;

FIG. 5D is a schematic view of a current direction of the pixel driving circuitry shown in FIG. 3 during a third compensation phase t23; and

FIG. 5E is a schematic view of a current direction of the pixel driving circuitry shown in FIG. 3 during a light-emitting phase t3.

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

The transistors in the present disclosure may be a thin film transistor, a field-effect transistor or other components having the same characteristic. In the embodiments of the present disclosure, in order to differentiate the two electrodes other than the gate electrode of transistor, the first electrode may be a source electrode and the second may be a drain electrode, or the first electrode may be a drain electrode and the second may be a source electrode.

In some embodiments of the present disclosure, the pixel driving circuitry includes N pixel driving sub-circuits coupled to an identical data line Data, an n^{th} pixel driving sub-circuit is configured to drive a light-emitting component of an n^{th} pixel unit to emit light, where N is an integer larger than 1, and n is a positive integer smaller than or equal to N.

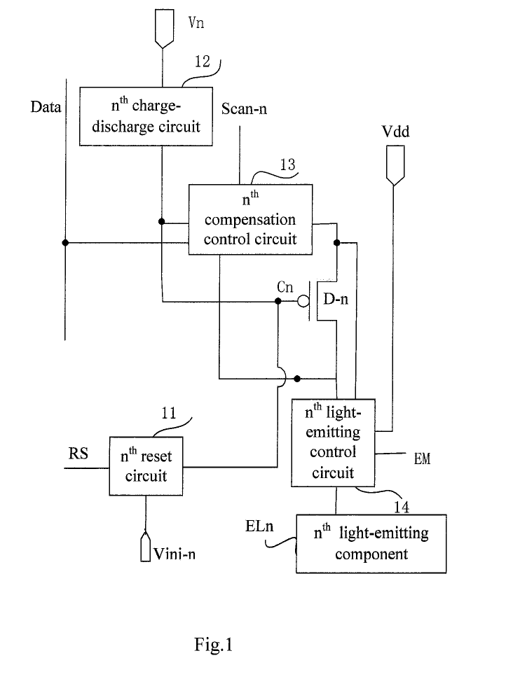

As shown in FIG. 1, the n^{th} pixel driving sub-circuit includes an n^{th} reset circuit 11, an n^{th} driving transistor D-n, an n^{th} charge-discharge circuit 12, an n^{th} compensation control circuit 13 and an n^{th} light-emitting control circuit 14.

The n^{th} reset circuit 11 is coupled to a reset control signal output end RS, an n^{th} initial signal output end configured to output an n^{th} initial signal Vini-n and an n^{th} control node Cn.

A gate electrode of the n^{th} driving transistor D-n is coupled to the n^{th} control node Cn, a first electrode of the n^{th} driving transistor D-n is coupled to the data line Data via the n^{th} compensation control circuit 13, and a second electrode of the n^{th} driving transistor D-n is coupled to a first end of the n^{th} charge-discharge circuit 12 via the n^{th} compensation control circuit 13.

The first end of the n^{th} charge-discharge circuit 12 is coupled to the n^{th} control node Cn, and a second end of the n^{th} charge-discharge circuit 12 is coupled to an n^{th} voltage output end configured to output an n^{th} voltage Vn.

The n^{th} compensation control circuit 13 is coupled to an n^{th} compensation control signal output end Scan-n and configured to, during an n^{th} compensation period of a compensation phase and in response to an n^{th} compensation control signal output by the n^{th} compensation control signal output end Scan-n, control the first electrode of the n^{th} driving transistor D-n to receive an n^{th} data voltage on the data line Data and control the n^{th} charge-discharge circuit 12 to charge or discharge until a potential of the n^{th} control node Cn reaches a sum of a threshold voltage of the n^{th} driving transistor D-n and the n^{th} data voltage.

The n^{th} light-emitting control circuit 14 is coupled to the first electrode of the n^{th} driving transistor D-n, the second electrode of the n^{th} driving transistor D-n, a high-level output end configured to output a high level Vdd, a light-emitting control line EM and an n^{th} light-emitting component ELn of the n^{th} pixel unit, and configured to, during a light-emitting phase and in response to a light-emitting control signal output by the light-emitting control line EM, turn on the n^{th} driving transistor D-n, drive the n^{th} light-emitting component ELn of the n^{th} pixel unit to emit light and enable a gate-to-source voltage of the n^{th} driving transistor D-n to compensate the threshold voltage of the n^{th} driving transistor D-n.

In a practical application, the N pixel driving sub-circuits coupled to an identical data line Data are arranged in different columns of an identical row respectively, and configured to drive respectively the N light-emitting components arranged in different columns of the identical row to emit light.

For example, the n^{th} driving transistor D-n in FIG. 1 is a P-type transistor. However, the n^{th} driving transistor D-n may also be an N-type transistor, and the type of the transistor is not limited herein.

In a practical application, the light-emitting component of the pixel unit may be an organic light-emitting diode (OLED).

In the pixel driving circuitry in some embodiments of the present disclosure, the initial signal output ends coupled to the reset circuits of the pixel driving sub-circuits respectively may output an identical initial signal or different initial signals, as long as the corresponding driving transistor may be turned on during the compensation phase.

In addition, in the pixel driving circuitry in some embodiments of the present disclosure, the voltage output ends coupled to the second ends of the charge-discharge circuits of the pixel driving sub-circuits respectively may output an identical voltage or different voltages, as long as during the compensation phase, a potential of the first end of the corresponding charge-discharge circuit may reach a sum of a threshold voltage of the corresponding driving transistor and the data voltage on the corresponding data line Data through charging or discharging.

The pixel driving circuitry in some embodiments of the present disclosure includes at least two pixel driving sub-circuits coupled to an identical data line Data and arranged in different columns of an identical row, and the data line Data provides the data voltage for the at least two pixel driving sub-circuits, thereby reducing the number of TFT components and data lines, so that it is able to reduce significantly the pixel pitch and the cost of the IC. As such, it is able to spare more data lines to arrange the IC channels, so as to achieve more PPI. In addition, it is able to control, by the compensation control circuit and during the compensation phase, the potential of the first end of the corresponding charge-discharge circuit to reach a sum of a threshold voltage of the n^{th} driving transistor D-n and the n^{th} data voltage, thereby enabling a gate-to-source voltage of the n^{th} driving transistor D-n to compensate the threshold voltage of the corresponding n^{th} driving transistor D-n during the light-emitting phase, so as to solve the technical issue that the threshold voltage may be inhomogenous due to a technological process and a long time operation of the pixel-driven TFT. As such, the current flowing through each pixel-point OLED may not be affected by the Vth, thereby guaranteeing a uniformity of the image display.

As shown in the drawings, in some embodiments of the present disclosure, the pixel driving circuitry includes three pixel driving sub-circuits (i.e., a first pixel driving sub-circuit PD1, a second pixel driving sub-circuit PD2 and a third pixel driving sub-circuit PD3) coupled to an identical data line Data.

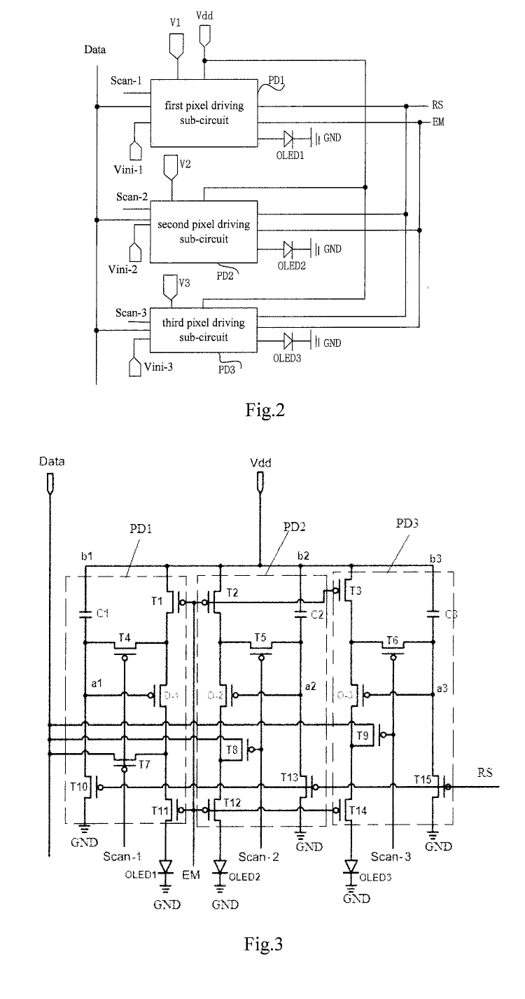

As shown in FIG. 2, in some embodiments of the present disclosure, the pixel driving circuitry includes a first pixel driving sub-circuit PD1, a second pixel driving sub-circuit PD2 and a third pixel driving sub-circuit PD3 coupled to an identical data line Data.

The first pixel driving sub-circuit PD1, the second pixel driving sub-circuit PD2 and the third pixel driving sub-circuit PD3 are further coupled to the high-level output end configured to output the high level Vdd, the reset control signal output end RS and the light-emitting control line EM.

The first pixel driving sub-circuit PD1 is further coupled to a first initial signal output end configured to output a first initial signal Vini-1, a first compensation control signal output end Scan-1, a first voltage output end configured to output a first voltage V1 and an anode of the first organic light-emitting diode OLED1.

The second pixel driving sub-circuit PD2 is further coupled to a second initial signal output end configured to output a second initial signal Vini-2, a second compensation control signal output end Scan-2, a second voltage output end configured to output a second voltage V2 and an anode of the second organic light-emitting diode OLED2.

The third pixel driving sub-circuit PD3 is further coupled to a third initial signal output end configured to output a third initial signal Vini-3, a third compensation control signal output end Scan-3, a third voltage output end configured to output a third voltage V3 and an anode of the third organic light-emitting diode OLED3.

Cathodes of the first organic light-emitting diode OLED1, the second organic light-emitting diode OLED2 and the third organic light-emitting diode OLED3 are coupled to the ground GND.

To be specific, the n^{th} reset circuit includes an n^{th} reset transistor, a gate electrode of the n^{th} reset transistor is coupled to the reset control signal output end, a first electrode of the n^{th} reset transistor is coupled to the n^{th} initial signal output end, and a second electrode of the n^{th} reset transistor is coupled to the n^{th} control node.

When the n^{th} driving transistor is a P-type transistor, a difference between an n^{th} initial signal output by the n^{th} initial signal output end and the n^{th} data voltage is smaller than the threshold voltage of the n^{th} driving transistor, so as to turn on the n^{th} driving transistor at the beginning of the compensation phase.

When the n^{th} driving transistor is an N-type transistor, a difference between an n^{th} initial signal output by the n^{th} initial signal output end and the n^{th} data voltage is larger than or equal to the threshold voltage of the n^{th} driving transistor, so as to turn on the n^{th} driving transistor at the beginning of the compensation phase.

In a practical application, the n^{th} data voltage may be such a value that during the compensation phase, a potential of the first end of the n^{th} charge-discharge circuit may reach a sum of a threshold voltage of the n^{th} driving transistor and the n^{th} data voltage through charging or discharging.

To be specific, the n^{th} charge-discharge circuit includes an n^{th} storage capacitor, a first end of the n^{th} storage capacitor is coupled to the n^{th} compensation control circuit, and a second end of the n^{th} storage capacitor is coupled to the voltage output end.

To be specific, the n^{th} compensation control circuit includes: a first compensation control transistor, where a gate electrode of the first compensation control transistor is coupled to the n^{th} compensation control signal output end, a first electrode of the first compensation control transistor is coupled to the data line, and a second electrode of the first compensation control transistor is coupled to the first electrode of the n^{th} driving transistor; and a second compensation control transistor, where a gate electrode of the second compensation control transistor is coupled to the n^{th} compensation control signal output end, a first electrode of the second compensation control transistor is coupled to the first end of the n^{th} charge-discharge circuit, and a second electrode of the second compensation control transistor is coupled to the second electrode of the n^{th} driving transistor.

To be specific, the n^{th} light-emitting control circuit includes: a first light-emitting control transistor, where a gate electrode of the first light-emitting control transistor is coupled to the light-emitting control line, a first electrode of the first light-emitting control transistor is coupled to the second electrode of the n^{th} driving transistor, and a second electrode of the first light-emitting control transistor is coupled to the high-level output end; and a second light-emitting control transistor, where a gate electrode of the second light-emitting control transistor is coupled to the light-emitting control line, a first electrode of the second light-emitting control transistor is coupled to the light-emitting component of the n^{th} pixel unit, and a second electrode of the second light-emitting control transistor is coupled to the first electrode of the n^{th} driving transistor.

Next, the pixel driving circuitry in the present disclosure will be described in conjunction with embodiments.

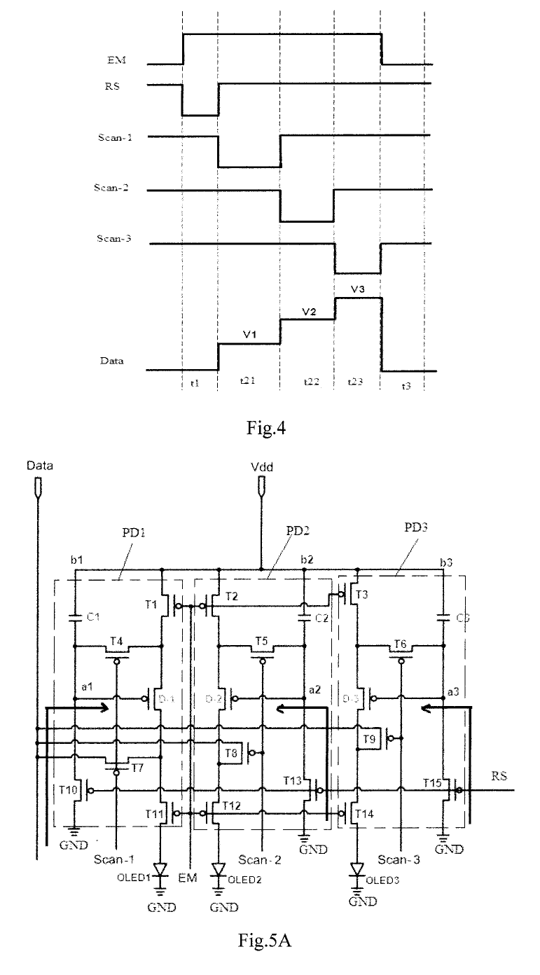

As shown in FIG. 3, in some embodiments of the present disclosure, the pixel driving circuitry includes a first pixel driving sub-circuit PD1, a second pixel driving sub-circuit PD2 and a third pixel driving sub-circuit PD3 coupled to an identical data line Data.

As shown in FIG. 3, in some embodiments of the present disclosure, the pixel driving circuitry includes 15 P-type transistors numbered T1 to T15 in sequence and three storage capacitors (i.e., a first storage capacitor C1, a second storage capacitor C2 and a third storage capacitor C3).

As shown in FIG. 3, in the pixel driving circuitry in some embodiments of the present disclosure, the three initial signal output ends are the GNDs, and the three voltage output ends are coupled to the high-level output end configured to output the high level Vdd.

The first pixel driving sub-circuit PD1 includes a first reset circuit, a first driving transistor D-1, a first charge-discharge circuit, a first compensation control circuit and a first light-emitting control circuit.

The first reset circuit includes a tenth transistor T10.

The first charge-discharge circuit includes a first storage capacitor C1.

The first compensation control circuit includes a fourth transistor T4 and a seventh transistor T7.

The first light-emitting control circuit includes a first transistor T1 and an eleventh transistor T11.

A gate electrode of the first driving transistor D-1 is coupled to a first control node a1, a drain electrode of the first driving transistor D-1 is coupled to the data line Data via the seventh transistor T7, and the drain electrode of the first driving transistor D-1 is further coupled to an anode of the first organic light-emitting diode OLED1 via the eleventh transistor T11. A source electrode of the first driving transistor D-1 is coupled to, via the first transistor T1, the high-level output end configured to output the high level Vdd, and the source electrode of the first driving transistor D-1 is further coupled to a first end of the first storage capacitor C1 via a fourth transistor T4.

Gate electrodes of the seventh transistor T7 and the fourth transistor T4 are coupled to the first compensation control signal output end Scan-1.

Gate electrodes of the first transistor T1 and the eleventh transistor T11 are coupled to the light-emitting control line EM.

A gate electrode of the tenth transistor T10 is coupled to the reset control signal output end RS, a drain electrode of the tenth transistor T10 is coupled to the GND, and a source electrode of the tenth transistor T10 is coupled to the first control node a1.

A cathode of the first organic light-emitting diode OLED1 is coupled to the GND.

The second pixel driving sub-circuit PD2 includes a second reset circuit, a second driving transistor D-2, a second charge-discharge circuit, a second compensation control circuit and a second light-emitting control circuit.

The second reset circuit includes a thirteenth transistor T13.

The second charge-discharge circuit includes a second storage capacitor C2.

The second compensation control circuit includes a fifth transistor T5 and an eighth transistor T8.

The second light-emitting control circuit includes a second transistor T2 and a twelfth transistor T12.

A gate electrode of the second driving transistor D-2 is coupled to a second control node a2, a drain electrode of the second driving transistor D-2 is coupled to the data line Data via the eighth transistor T8, and the drain electrode of the second driving transistor D-2 is further coupled to an anode of the second organic light-emitting diode OLED2 via the twelfth transistor T12. A source electrode of the second driving transistor D-2 is coupled to, via the second transistor T2, the high-level output end configured to output the high level Vdd, and the source electrode of the second driving transistor D-2 is further coupled to a first end of the second storage capacitor C2 via a fifth transistor T5.

Gate electrodes of the fifth transistor T5 and the eighth transistor T8 are coupled to the second compensation control signal output end Scan-2.

Gate electrodes of the second transistor T2 and the twelfth transistor T12 are coupled to the light-emitting control line EM.

A gate electrode of the thirteenth transistor T13 is coupled to the reset control signal output end RS, a drain electrode of the thirteenth transistor T13 is coupled to the GND, and a source electrode of the thirteenth transistor T13 is coupled to the second control node a2.

A cathode of the second organic light-emitting diode OLED2 is coupled to the GND.

The third pixel driving sub-circuit PD3 includes a third reset circuit, a third driving transistor D-3, a third charge-discharge circuit, a third compensation control circuit and a third light-emitting control circuit.

The third reset circuit includes a fifteenth transistor T15.

The third charge-discharge circuit includes a third storage capacitor C3.

The third compensation control circuit includes a sixth transistor T6 and a ninth transistor T9.

The third light-emitting control circuit includes a third transistor T3 and a fourteenth transistor T14.

A gate electrode of the third driving transistor D-3 is coupled to a third control node a3, a drain electrode of the third driving transistor D-3 is coupled to the data line Data via the ninth transistor T9, and the drain electrode of the third driving transistor D-3 is further coupled to an anode of the third organic light-emitting diode OLED3 via the fourteenth transistor T14. A source electrode of the third driving transistor D-3 is coupled to, via the third transistor T3, the high-level output end configured to output the high level Vdd, and the source electrode of the third driving transistor D-3 is further coupled to a first end of the third storage capacitor C3 via a sixth transistor T6.

Gate electrodes of the sixth transistor T6 and the ninth transistor T9 are coupled to the third compensation control signal output end Scan-3.

Gate electrodes of the third transistor T3 and the fourteenth transistor T14 are coupled to the light-emitting control line EM.

A gate electrode of the fifteenth transistor T15 is coupled to the reset control signal output end RS, a drain electrode of the fifteenth transistor T15 is coupled to the GND, and a source electrode of the fifteenth transistor T15 is coupled to the third control node a3.

A cathode of the third organic light-emitting diode OLED3 is coupled to the GND.

A second end b1 of the first storage capacitor C1, a second end b2 of the second storage capacitor C2 and a second end b3 of the third storage capacitor C3 are coupled to the high-level output end configured to output the high level Vdd.

In some embodiments of the present disclosure, as shown in FIG. 3, the transistors are all P-type transistors. However, in a practical application, the transistors may be N-type transistors, as long as to adjust a potential of a signal input to the gate electrode and potentials of the control signals.

Next, a working process of the pixel driving circuitry in some embodiments of the present disclosure will be described in a time sequence diagram and a schematic view showing a turned-on transistor.

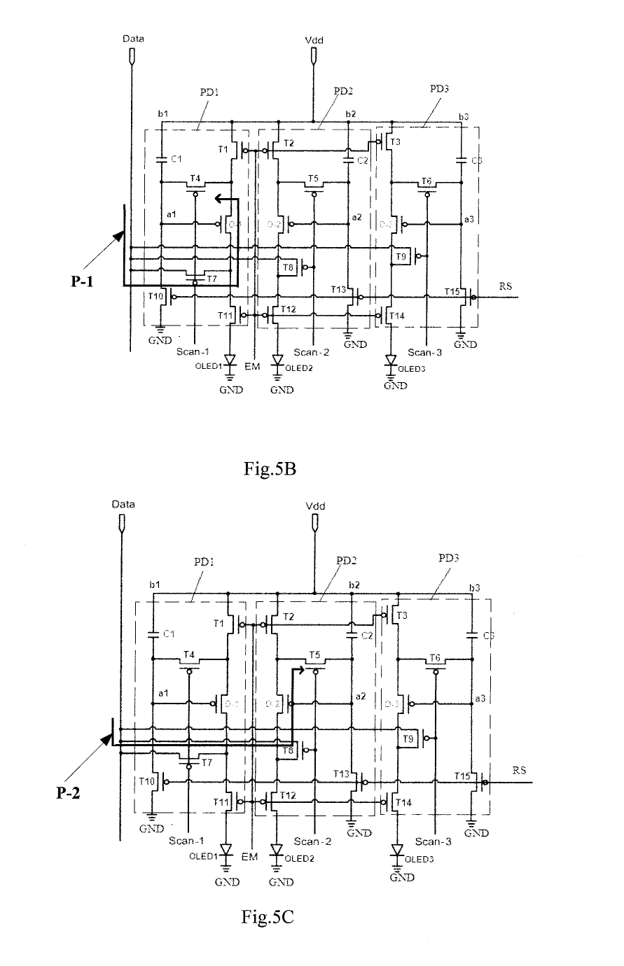

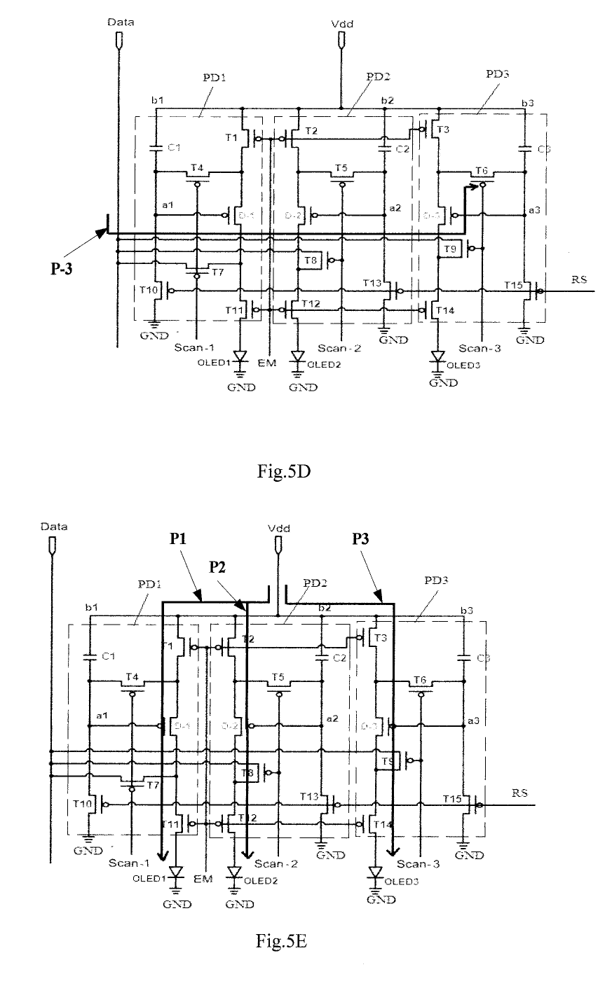

As show in FIG. 4 and FIG. 5A, during a reset phase t1 of each display period, the reset control signal output end RS outputs a low-level reset control signal. The tenth transistor T10, thirteenth transistor T13 and fifteenth transistor T15 are turned-on, while the other transistors are turned off, the first control node a1, the second control node a2 and the third control node a3 are grounded, and the second end b1, the second end b2 and the second end b3 are coupled to the Vdd.

As show in FIG. 4 and FIG. 5B, during a first compensation phase t21 of each display period which is also a first pixel charging phase, the first compensation control signal output end Scan-1 outputs a low level, the fourth transistor T4 and seventh transistor T7 are turned on, and the data line Data outputs a first data voltage V1. At this time, the first storage capacitor C1 of the first pixel driving sub-circuit is charged along a path P-1 shown in FIG. 5B. That is, by the first data voltage V1 and through the seventh transistor T7, the first driving transistor D-1 and the fourth transistor T4, the first storage capacitor C1 is charged. At this time, a potential of the first control node a1 is equal to V1+Vth1, a potential of the second end b1 is the Vdd, where Vth1 is a threshold voltage of the first driving transistor D-1. Because the first driving transistor D-1 is a P-type transistor, the value of the Vth1 is negative.

As show in FIG. 4 and FIG. 5C, during a second compensation phase t22 of each display period which is also a second pixel charging phase, the second compensation control signal output end Scan-2 outputs a low level, the fifth transistor T5 and eighth transistor T8 are turned on, and the data line Data outputs a second data voltage V2. At this time, the second storage capacitor C2 of the second pixel driving sub-circuit is charged along a path P-2 shown in FIG. 5C. That is, by the second data voltage V2 and through the eighth transistor T8, the second driving transistor D-2 and the fifth transistor T5, the second storage capacitor C2 is charged. At this time, a potential of the second control node a2 is equal to V2+Vth2, a potential of the second end b1 is the Vdd, where Vth2 is a threshold voltage of the second driving transistor D-2. Because the second driving transistor D-2 is a P-type transistor, the value of the Vth2 is negative.

As show in FIG. 4 and FIG. 5D, during a third compensation phase t23 of each display period which is also a third pixel charging phase, the third compensation control signal output end Scan-3 outputs a low level, the sixth transistor T6 and ninth transistor T9 are turned on, and the data line Data outputs a third data voltage V3. At this time, the third storage capacitor C3 of the third pixel driving sub-circuit is charged along a path P-3 shown in FIG. 5D. That is, by the third data voltage V3 and through the ninth transistor T9, the third driving transistor D-3 and the sixth transistor T6, the third storage capacitor C3 is charged. At this time, a potential of the third control node a3 is equal to V3+Vth3, a potential of the second end b3 is the Vdd, where Vth3 is a threshold voltage of the third driving transistor D-3. Because the third driving transistor D-3 is a P-type transistor, the value of the Vth3 is negative.

As show in FIG. 4 and FIG. 5E, during a light-emitting phase t3 of each display period, an active-matrix organic light emitting diode (AMOLED) pixel emits light, the light-emitting control line EM outputs a low level and a signal of the EM is pulled down, the source electrodes of the first driving transistor D-1, the second driving transistor D-2 and the third driving transistor D-3 are coupled to the Vdd, and the three pixels emit light through respective paths P1, P2 and P3. According to a saturation current formula of the driving transistor, a I_{OLED1} flowing through the first organic light-emitting diode OLED1, a I_{OLED2} flowing through the second organic light-emitting diode OLED2 and a I_{OLED3} flowing through the third organic light-emitting diode OLED3 may be obtained through the following functions: I_{OLED1}=K1×(V_{GS1}−Vₜₕ₁)²=K1×[V1+Vth1−Vdd−Vth1]²=K1×(Vdd V1)², I_{OLED2}=K2×(Vdd V2)², I_{OLED3}=K3×(Vdd−V3)², where K1 is a current factor of the first driving transistor D-1, K2 is a current factor of the second driving transistor D-2, K13 is a current factor of the third driving transistor D-3, V_{GS1} is a gate-source voltage of the first driving transistor D-1, V_{GS2} is a gate-source voltage of the second driving transistor D-2, V_{GS3} is a gate-source voltage of the third driving transistor D-3.

It can be seen from the above functions, now a working current of the OLED is not affected by the corresponding driving transistor and merely related to the data voltage on the data line Data, thereby solving the technical issue that the threshold voltage may drift due to a technological process and a long time operation of the driving transistor, eliminating the affect of the threshold value to the working current of the OLED, and guaranteeing that that OLED may work normally.

According to the pixel driving circuitry in some embodiments of the present disclosure, three pixels are driven through one compensation circuit, thereby reducing the number of the TFT for compensation, reducing significantly the pixel pitch and the cost of the IC, and achieving a higher image quality and more PPI.

In a practical application, in the pixel driving circuitry in some embodiments of the present disclosure, when the driving transistor is a N-type transistor, the first, the second and the third compensation phases are the phases when the storage capacitor discharges.

A method for driving the above pixel driving circuitry is further provided in some embodiments of the present disclosure, where each display period includes a reset phase, a compensation phase and a light-emitting control phase; the compensation phase includes N compensation periods, where N is a number of pixel driving sub-circuits of the pixel driving circuitry; during each display period, the method includes: during the reset phase, and in response to a reset control signal, controlling, by a reset control circuit, each control node to receive a corresponding initial signal; during an n^{th} compensation period of the compensation phase, and in response to an n^{th} compensation control signal, controlling, by the n^{th} compensation control circuit, the first electrode of the n^{th} driving transistor to receive an n^{th} data voltage on the data line, controlling, by the n^{th} compensation control circuit, the n^{th} control node to connect to the second electrode of the n^{th} driving transistor, and controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage; during the light-emitting phase, and in response to a light-emitting control signal output by the light-emitting control line, turning on the n^{th} driving transistor by the n^{th} light-emitting control circuit, driving, by the n^{th} light-emitting control circuit, the light-emitting component of the n^{th} pixel unit to emit light and enabling a gate-to-source voltage of the n^{th} driving transistor to compensate the threshold voltage of the n^{th} driving transistor; where n is a positive integer smaller than or equal to N.

To be specific, the n^{th} driving transistor is a P-type transistor, and a difference between an n^{th} initial signal and the n^{th} data voltage is smaller than the threshold voltage of the n^{th} driving transistor, so as to turn on the n^{th} driving transistor at the beginning of the compensation phase.

The controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage further includes: controlling, by the n^{th} compensation control circuit, the n^{th} charge-discharge circuit to charge until the potential of the n^{th} control node reaches the sum of the threshold voltage of the n^{th} driving transistor and the n^{th} data voltage.

To be specific, the n^{th} driving transistor is an N-type transistor, and a difference between an n^{th} initial signal output by the n^{th} initial signal output end and the n^{th} data voltage is larger than or equal to the threshold voltage of the n^{th} driving transistor, so as to turn on the n^{th} driving transistor at the beginning of the compensation phase.

The controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage further includes: controlling, by the n^{th} compensation control circuit, the n^{th}charge-discharge circuit to discharge until the potential of the n^{th} control node reaches the sum of the threshold voltage of the n^{th} driving transistor and the n^{th} data voltage.

A display substrate is further provided in some embodiments of the present disclosure, including a plurality of date lines and a pixel structure. The pixel structure includes a plurality of rows and columns of pixel units arranged in an array and a plurality of pixel driving circuitry hereinabove. N pixel driving sub-circuits of the pixel driving circuitry are coupled to an identical data line. The N pixel driving sub-circuits are respectively coupled to the light-emitting components of N pixel units arranged in a row identical to the N pixel driving sub-circuits, where N is an integer larger than 1.

In a practical application, when N=3, the three pixel driving sub-circuits of the pixel driving circuitry in some embodiments of the present disclosure may be the pixel driving sub-circuits configured to drive respectively a red sub-pixel, a green sub-pixel and a blue sub-pixel in an identical row from left to right, or the three pixel driving sub-circuits of the pixel driving circuitry in some embodiments of the present disclosure may be the pixel driving sub-circuits configured to drive respectively a green sub-pixel, a blue sub-pixel and a red sub-pixel in an identical row from left to right, or the three pixel driving sub-circuits of the pixel driving circuitry in some embodiments of the present disclosure may be the pixel driving sub-circuits configured to drive respectively a blue sub-pixel, a red sub-pixel and a green sub-pixel in an identical row from left to right.

Optionally, the display substrate further includes a silicon substrate, where the date line, the pixel units and the pixel driving circuitry are arranged on the silicon substrate.

In some embodiments of the present disclosure, a base substrate of the display substrate is a monocrystalline substrate, and the active regions of the transistors in an array circuit layer of the pixel driving circuitry are arranged within the monocrystalline substrate. Because a monocrystalline material has high carrier mobility, the transistors in the pixel driving circuitry may have a good performance meanwhile a size of the transistor may be reduced. As such, the pixel driving circuitry may not occupy a large area of the substrate, and the pixel driving circuitry may be formed with the substrate.

A display device including the above display substrate is provided in some embodiments of the present disclosure.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

1. A pixel driving circuitry, comprising N pixel driving sub-circuits coupled to an identical data line, wherein an n^{th} pixel driving sub-circuit is configured to drive a light-emitting component of an n^{th} pixel unit to emit light, wherein N is an integer larger than 1, and n is a positive integer smaller than or equal to N;
the n^{th} pixel driving sub-circuit comprises an n^{th} reset circuit, an n^{th} driving transistor, an n^{th} charge-discharge circuit, an n^{th} compensation control circuit and an n^{th} light-emitting control circuit, wherein
the n^{th} reset circuit is coupled to a reset control signal output end, an n^{th} initial signal output end and an n^{th} control node;
a gate electrode of the n^{th} driving transistor is coupled to the n^{th} control node, a first electrode of the n^{th} driving transistor is coupled to the data line via the n^{th} compensation control circuit, and a second electrode of the n^{th} driving transistor is coupled to a first end of the n^{th} charge-discharge circuit via the n^{th} compensation control circuit;
the first end of the n^{th} charge-discharge circuit is coupled to the n^{th} control node, and a second end of the n^{th} charge-discharge circuit is coupled to a voltage output end;
the n^{th} compensation control circuit is coupled to an n^{th} compensation control signal output end and configured to, during an n^{th} compensation period of a compensation phase and in response to an n^{th} compensation control signal, control the first electrode of the n^{th} driving transistor to receive an n^{th} data voltage on the data line and control the n^{th} charge-discharge circuit to charge or discharge to control a potential of the n^{th} control node;
the n^{th} light-emitting control circuit is coupled to the first electrode of the n^{th} driving transistor, the second electrode of the n^{th} driving transistor, a first voltage output end, a light-emitting control line and the light-emitting component of the n^{th} pixel unit, and configured to, in response to a light-emitting control signal output by the light-emitting control line, turn on the n^{th} driving transistor, drive the light-emitting component of the n^{th} pixel unit to emit light.

2. The pixel driving circuitry according to claim 1, wherein the n^{th} reset circuit comprises an n^{th} reset transistor, a gate electrode of the n^{th} reset transistor is coupled to the reset control signal output end, a first electrode of the n^{th} reset transistor is coupled to the n^{th} initial signal output end, and a second electrode of the n^{th} reset transistor is coupled to the n^{th} control node;
then driving transistor is a P-type transistor.

3. The pixel driving circuitry according to claim 1, wherein the n^{th} reset circuit comprises an n^{th} reset transistor, a gate electrode of the n^{th} reset transistor is coupled to the reset control signal output end, a first electrode of the n^{th} reset transistor is coupled to the n^{th} initial signal output end, and a second electrode of the n^{th} reset transistor is coupled to the n^{th} control node;
the n^{th} driving transistor is an N-type transistor.

4. The pixel driving circuitry according to claim 1, wherein the n^{th} charge-discharge circuit comprises an n^{th} storage capacitor, a first end of the n^{th} storage capacitor is coupled to the n^{th} compensation control circuit, and a second end of the n^{th} storage capacitor is coupled to the voltage output end.

5. The pixel driving circuitry according to claim 1, wherein the n^{th} compensation control circuit comprises:
a first compensation control transistor, wherein a gate electrode of the first compensation control transistor is coupled to the n^{th} compensation control signal output end, a first electrode of the first compensation control transistor is coupled to the data line, and a second electrode of the first compensation control transistor is coupled to the first electrode of the n^{th} driving transistor; and
a second compensation control transistor, wherein a gate electrode of the second compensation control transistor is coupled to the n^{th} compensation control signal output end, a first electrode of the second compensation control transistor is coupled to the first end of the n^{th} charge-discharge circuit, and a second electrode of the second compensation control transistor is coupled to the second electrode of the n^{th} driving transistor.

6. The pixel driving circuitry according to claim 1, wherein the n^{th} light-emitting control circuit comprises:
a first light-emitting control transistor, wherein a gate electrode of the first light-emitting control transistor is coupled to the light-emitting control line, a first electrode of the first light-emitting control transistor is coupled to the second electrode of the n^{th} driving transistor, and a second electrode of the first light-emitting control transistor is coupled to the first voltage output end; and
a second light-emitting control transistor, wherein a gate electrode of the second light-emitting control transistor is coupled to the light-emitting control line, a first electrode of the second light-emitting control transistor is coupled to the light-emitting component of the n^{th} pixel unit, and a second electrode of the second light-emitting control transistor is coupled to the first electrode of the n^{th} driving transistor.

7. The pixel driving circuitry according to claim 1, wherein the n^{th} initial signal output end is a ground end, and the voltage output end is coupled to the first voltage output end.

8. A method for driving the pixel driving circuitry according to claim 1, wherein each display period comprises a reset phase, a compensation phase and a light-emitting control phase; the compensation phase comprises N compensation periods, wherein N is a number of pixel driving sub-circuits of the pixel driving circuitry;
during each display period, the method comprises:
during the reset phase, and in response to a reset control signal, controlling, by a reset control circuit, each control node to receive a corresponding initial signal;
during an n^{th} compensation period of the compensation phase, and in response to an n^{th} compensation control signal, controlling, by the n^{th} compensation control circuit, the first electrode of the n^{th} driving transistor to receive an n^{th} data voltage on the data line, controlling, by the n^{th} compensation control circuit, the n^{th} control node to connect to the second electrode of the n^{th} driving transistor, and controlling, by the n^{th} compensation control circuit, the n^{th} charge-discharge circuit to charge or discharge to control a potential of the n^{th} control node;
in response to a light-emitting control signal output by the light-emitting control line, turning on the n^{th} driving transistor by the n^{th} light-emitting control circuit, driving, by the n^{th} light-emitting control circuit, the light-emitting component of the n^{th} pixel unit to emit light;
wherein n is a positive integer smaller than or equal to N.

9. The method according to claim 8, wherein the n^{th} driving transistor is a P-type transistor;
the controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage further comprises: controlling, by the n^{th} compensation control circuit, the n^{th} charge-discharge circuit to charge to the control the potential of then control node.

10. The method according to claim 8, wherein the n^{th} driving transistor is an N-type transistor;
the controlling, by the n^{th} compensation control circuit, the n^{th} charge-discharge circuit to charge or discharge until a potential of the n^{th} control node reaches a sum of a threshold voltage of the n^{th} driving transistor and the n^{th} data voltage further comprises: controlling, by the n^{th} compensation control circuit, the n^{th} charge-discharge circuit to discharge to control the potential of the n^{th} control node.

11. A display substrate, comprising a plurality of date lines and a pixel structure;
the pixel structure comprises a plurality of rows and columns of pixel units arranged in an array and a plurality of pixel driving circuitry according to claim 1;
N pixel driving sub-circuits of the pixel driving circuitry are coupled to an identical data line;
the N pixel driving sub-circuits are respectively coupled to the light-emitting components of N pixel units arranged in a row identical to the N pixel driving sub-circuits, wherein N is an integer larger than 1.

12. The display substrate according to claim 11, further comprising a silicon substrate, wherein the date line, the pixel units and the pixel driving circuitry are arranged on the silicon substrate.

13. A display device comprising the display substrate according to claim 11.

14. A display device comprising the display substrate according to claim 12.

15. The pixel driving circuit according to claim 2, wherein the n^{th} compensation control module comprises:
a first compensation control transistor, wherein a gate electrode of the first compensation control transistor is connected to the n^{th} compensation control signal output end, a first electrode of the first compensation control transistor is connected to the data line, and a second electrode of the first compensation control transistor is connected to the first electrode of the n^{th} driving transistor; and
a second compensation control transistor, wherein a gate electrode of the second compensation control transistor is connected to the n^{th} compensation control signal output end, a first electrode of the second compensation control transistor is connected to the first end of the n^{th} charge-discharge module, and a second electrode of the second compensation control transistor is connected to the second electrode of the n^{th} driving transistor.

16. The pixel driving circuit according to claim 3, wherein the n^{th} compensation control module comprises:
a first compensation control transistor, wherein a gate electrode of the first compensation control transistor is connected to the n^{th} compensation control signal output end, a first electrode of the first compensation control transistor is connected to the data line, and a second electrode of the first compensation control transistor is connected to the first electrode of the n^{th} driving transistor; and
a second compensation control transistor, wherein a gate electrode of the second compensation control transistor is connected to the n^{th} compensation control signal output end, a first electrode of the second compensation control transistor is connected to the first end of the n^{th} charge-discharge module, and a second electrode of the second compensation control transistor is connected to the second electrode of the n^{th} driving transistor.

17. The pixel driving circuit according to claim 4, wherein the n^{th} compensation control module comprises:
a first compensation control transistor, wherein a gate electrode of the first compensation control transistor is connected to the n^{th} compensation control signal output end, a first electrode of the first compensation control transistor is connected to the data line, and a second electrode of the first compensation control transistor is connected to the first electrode of the n^{th} driving transistor; and
a second compensation control transistor, wherein a gate electrode of the second compensation control transistor is connected to the n^{th} compensation control signal output end, a first electrode of the second compensation control transistor is connected to the first end of the n^{th} charge-discharge module, and a second electrode of the second compensation control transistor is connected to the second electrode of the n^{th} driving transistor.

18. The pixel driving circuit according to claim 2, wherein the n^{th} light-emitting control module comprises:
a first light-emitting control transistor, wherein a gate electrode of the first light-emitting control transistor is connected to the light-emitting control line, a first electrode of the first light-emitting control transistor is connected to the second electrode of the n^{th} driving transistor, and a second electrode of the first light-emitting control transistor is connected to the first voltage output end; and
a second light-emitting control transistor, wherein a gate electrode of the second light-emitting control transistor is connected to the light-emitting control line, a first electrode of the second light-emitting control transistor is connected to the light-emitting component of the n^{th} pixel unit, and a second electrode of the second light-emitting control transistor is connected to the first electrode of the n^{th} driving transistor.

19. The pixel driving circuit according to claim 3, wherein the n^{th} light-emitting control module comprises:
a first light-emitting control transistor, wherein a gate electrode of the first light-emitting control transistor is connected to the light-emitting control line, a first electrode of the first light-emitting control transistor is connected to the second electrode of the n^{th} driving transistor, and a second electrode of the first light-emitting control transistor is connected to the first voltage output end; and
a second light-emitting control transistor, wherein a gate electrode of the second light-emitting control transistor is connected to the light-emitting control line, a first electrode of the second light-emitting control transistor is connected to the light-emitting component of the n^{th} pixel unit, and a second electrode of the second light-emitting control transistor is connected to the first electrode of the n^{th} driving transistor.

20. The pixel driving circuit according to claim 4, wherein the n^{th} light-emitting control module comprises:
a first light-emitting control transistor, wherein a gate electrode of the first light-emitting control transistor is connected to the light-emitting control line, a first electrode of the first light-emitting control transistor is connected to the second electrode of the n^{th} driving transistor, and a second electrode of the first light-emitting control transistor is connected to the first voltage output end; and
a second light-emitting control transistor, wherein a gate electrode of the second light-emitting control transistor is connected to the light-emitting control line, a first electrode of the second light-emitting control transistor is connected to the light-emitting component of the n^{th} pixel unit, and a second electrode of the second light-emitting control transistor is connected to the first electrode of the n^{th} driving transistor.
